(19) United States
(12) Patent Application Publication
(10) Pub. No.: US 2020/0304708 A1
(43) Pub. Date: Sep. 24, 2020

(54) METHOD AND APPARATUS FOR ACQUIRING AN IMAGE

(71) Applicant: MOTOROLA SOLUTIONS, INC, CHICAGO, IL (US)

(72) Inventors: KUAN HENG LEE, AIR ITAM (MY); TIH HUANG YEOH, KANGAR (MY); ALWIN SONG GEN OOI, BAYAN LEPAS (MY); ANIL KUMAR VADLAMUDI, ADDANKI (IN); LEE SUN OOI, KULIM (MY); MOH LIM SIM, BAYAN LEPAS (MY)

(21) Appl. No.: 16/355,890

(22) Filed: Mar. 18, 2019

(51) Int. Cl. H04N 5/232; H04N 5/77; H04N 5/262; G10L 15/22; G10L 25/57; G11B 20/10

(52) U.S. Cl. CPC H04N 5/23219; H04N 5/772; G11B 20/10527; G10L 15/22; G10L 25/57; H04N 5/2628

(57) ABSTRACT

A method and apparatus for acquiring an image is provided herein. During operation a determination is made that a user is intending to tag an object through pointing a finger at the object. In response, a pre-buffer is accessed, and an image of the object is selected from the pre-buffer that is absent the user's hand. Once the image has been selected, the image can be forwarded to other users.

### BACKGROUND OF THE INVENTION

Continuous recording on wearable cameras used by public safety officers introduces challenges. One challenge facing the cameras is the amount of data acquired by a continuously-recording camera. Analyzing and storing terabytes of video footage consumes lots of time and resources (human and/or computing). Therefore, manual activation of wearable cameras is preferred. Oftentimes, manual activation of a camera misses a critical moment that triggered the activation. Because of this, police cameras perform pre-event buffering.

Pre-event buffering involves pre-loading video into a certain area of memory known as a “buffer,” so the video can be pre-pended to any recording initiated by a user. In other words, during pre-event buffering, the camera continuously pre-records video and will constantly re-write video older than, say, 30 seconds. When a user initiates recording, the contents of the buffer are pre-pended to any recording. Thus, during pre-buffering, continuous video recording takes place and is stored to a pre-buffer; overwriting the beginning of the video after, say, 30 seconds, to allow for new footage to be captured, which can help to conserve space.

International Publication Number WO 2016/048633A1 (incorporated by reference herein, and referred to herein as the '633 publication), entitled, SYSTEMS, APPARATUSES, AND METHODS FOR GESTURE RECOGNITION AND INTERACTION describes controlling a camera via gestures. One of the interactions described in the '633 publication is acquiring an image of an object via pointing at an object. A problem exists in that images acquired in this manner will have a user's hand or finger as part of the image. It would be beneficial for a police officer if such a gesture-based technique could be used for acquiring an image that results in the user's hand or finger being absent from the image.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 shows an example of an apparatus for performing the task of cropping an image from pre-buffer video.

FIG. 2 illustrates acquiring an image from a pre-buffer.

FIG. 3 is a flow chart showing operation of the apparatus of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to provide a gesture-based technique that can be used for acquiring an image that results in the user's hand or finger being absent from the image, a method and apparatus for acquiring an image is provided herein. During operation a determination is made that a user is intending to tag an object through pointing a finger at the object. In response, a pre-buffer is accessed, and an image of the object is selected from the pre-buffer that is absent the user's hand. Once the image has been selected, the image can be forwarded to other users.

It should be noted that since the pre-buffer typically comprises video, the image of the object may be acquired by cropping the image from the video stored within the pre-buffer.

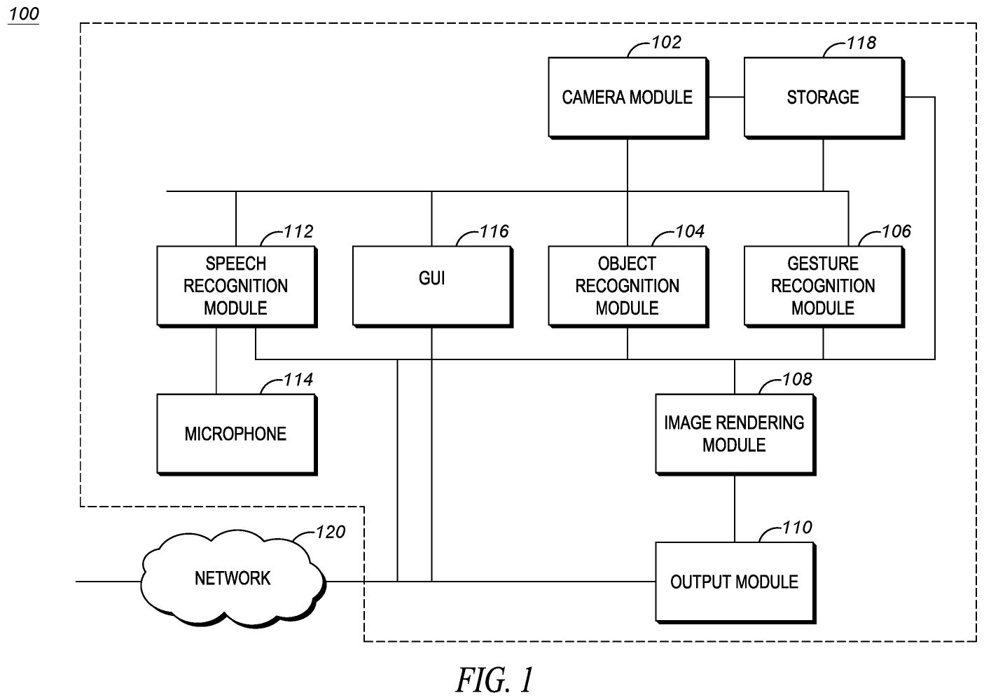

FIG. 1 shows an example of apparatus 100 for performing the task of cropping an image from pre-buffer video, in accord with one or more embodiments. Apparatus 100 may include a camera module 102, storage 118, an object recognition module 104, a gesture recognition module 106, an image rendering module 108, and an output module 110.

Storage 118 comprises standard memory (such as RAM, ROM, . . . , etc.) and serves to store a predetermined amount (e.g., 30 seconds) of continuously-provided video from camera module 102. In other words, at least part of storage 118 acts as a pre-buffer. Storage 118 also serves to store any video taken by camera module 102 when camera module 102 is activated.

The camera module 102 may translate a scene in a field of view of the camera module 102 into image data (e.g., video, still, or other image data). The camera module 102 may include a digital camera, video camera, camera phone, or other image capturing device.

The object recognition module 104 may detect or recognize (e.g., detect and identify) an object in the image data. The object recognition module 104 may delineate (e.g., extract) an object from the image data, such as to isolate the object from the surrounding environment in the field of view of the camera module 102 or in the image data. The object recognition module 104 may use at least one of an appearance-based method or feature-based method, among other methods, to detect, recognize, or delineate an object.

The appearance-based method may include generally comparing a representation of an object to the image data to determine if the object is present in the image. Examples of appearance-based object detection methods include an edge matching, gradient matching, color (e.g., greyscale) matching, “divide-and-conquer”, a histogram of image point relations, a model base method, or a combination thereof, among others. The edge matching method may include an edge detection method that includes a comparison to templates of edges of known objects. The color matching method may include comparing pixel data of an object from image data to previously determined pixel data of reference objects. The gradient matching method may include comparing an image data gradient to a reference image data gradient.

The “divide-and-conquer” method may include comparing known object data to the image data. The histogram of image point relations may include comparing relations of image points in a reference image of an object to the image data captured. The model base method may include comparing a geometric model (e.g., eigenvalues, eigenvectors, or “eigenfaces”, among other geometric descriptors) of an object, such as may be stored in a model database, to the image data. These methods may be combined, such as to provide a more robust object detection method.

The feature-based method may include generally comparing a representation of a feature of an object to the image data to determine if the feature is present, and inferring that the object is present in the image data if the feature is present. Examples of features of objects include a surface feature, corner, or edge shape. The feature-based method may include a Speeded Up Robust Feature (SURF), a Scale-Invariant Feature Transform (SIFT), a geometric hashing, an invariance, a pose clustering or consistency, a hypothesis and test, an interpretation tree, or a combination thereof, among other methods.

Delineating an object may include determining an outline or silhouette of an object and determining image data (e.g., pixel values) within the outline or silhouette. The determined image data or pixel values may be displayed or provided without displaying or providing the remaining image data of the image the object was delineated from. The delineated object may be displayed over a still image or otherwise displayed using the output module 110. A user may cause an image to be acquired of the object (as discussed above) by performing a gesture (e.g., pointing at the object).

The gesture recognition module 106 may identify a hand or finger in image data (e.g., image data corresponding to a single image or image data corresponding to a series of images or multiple images) and determine its motion or configuration to determine if a recognizable gesture has been performed. When the gesture recognition module 106 detects a pointing gesture, a notification will be sent to the object recognition module 104 so that the object recognition module will determine what object the user is pointing at, and attempt to identify the object.

The gesture recognition module 106 may use a three-dimensional or two-dimensional recognition method. Generally, a two-dimensional recognition method requires fewer computer resources to perform gesture recognition than a three-dimensional method. The gesture recognition module 106 may implement a skeletal-based method or an appearance-based method, among others. The skeletal-based method includes modeling a finger or hand as one or more segments and one or more angles between the segments. The appearance-based model includes using a template of a hand or finger and comparing the template to the image data to determine if a hand or finger substantially matching the template appears in the image data.

The image rendering module 108 renders an image of the object from pre-buffer 118. As discussed above, the image of the object is preferably an image from a video stored in pre-buffer 118 that is not blocked by the user pointing at the object. More particularly, when gesture recognition module 106 determines that a pointing gesture has been made, object recognition module 104 is notified, and attempts to identify the object that is being pointed at. Once identified, the identity of the object is provided to image rendering module 108.

The identity of the object may simply comprise a location of the object within the video, a “name” of the object, a color of the object, or any other distinguishing characteristic of the object. For example, if a user is pointing at a white automobile, the object recognition module 104 may provide “white automobile” to the image rendering module 108. In another embodiment of the present invention, image rendering module 108 may be provided with an image of the object (including the user's hand, pointing at the object). The image rendering module 108 may identify the white automobile and access pre-buffer 118 to determine a best image from pre-buffer of the white automobile. Image rendering module 108 selects the best image of the white automobile from the pre-buffer 118 (i.e., one that isn't blocked by a user's hand or finger). The best image may be cropped from the video frame.

It should be noted that when the “pointing” gesture is detected, activation of the camera may take place. So for example, once gesture recognition module 106 detects a pointing gesture, gesture recognition module 106 may send a signal to camera module to begin recording video. As discussed above, the contents of pre-buffer 118 will be pre-pended to any recorded video by camera module 102.

The output module 110 may comprise a radio connection (wireless) or and/or a wired connection to network 120. For example, output module 110 may comprise a network interface that includes elements including processing, modulating, and transceiver elements that are operable in accordance with any one or more standard or proprietary wired or wireless interfaces. Examples of network interfaces (wired or wireless) include Ethernet, T1, USB interfaces, IEEE 802.11b, IEEE 802.11g, etc.

The speech recognition module 112 acts as a natural-language processor (NLP) to interpret a sound (e.g., a word or phrase) captured by a microphone 114 and provide data indicative of the interpretation. The sound may be interpreted using a Hidden Markov Model (HMM) method or a neural network method, among others. Speech recognition module 112 analyzes, understands, and derives meaning from human language in a smart and useful way. By utilizing NLP, voice to text conversion, automatic summarization, translation, named entity recognition, relationship extraction, sentiment analysis, speech recognition, and topic segmentation can take place. In some examples, NLP can simply perform voice to text conversion to convert the received voice data (from microphone) to text and then input the text to any module shown in FIG. 1.

Graphical User Interface (GUI) 116 provides a man/machine interface for receiving an input from a user and displaying information. For example, GUI 116 may provide a way of conveying (e.g., displaying) images/video received from camera 102 or image rendering module 108. With this in mind, GUI 116 may comprise any combination of a touch screen, a computer screen, a keyboard, or any other interface needed to receive a user input and provide information to the user.

The apparatus 100 may include a wired or wireless connection to a network 120 (e.g., the internet or a cellular or WiFi network, among others). The network 120 may provide data that may be provided to a user, such as through the output module 110. For example, the network 120 may provide directions, data about an object in the image data, an answer to a question posed through the speech recognition module 112, an image (e.g., video or series of images) requested, or other data. networks 120 also serves to provide images obtained by image rendering module 108 to other users of network 120.

In one or more embodiments, a user may name an object while pointing at the object. For example, the user may point to one of multiple people or objects and say a name. Subsequently, speech recognition module 112 may provide the “name” of the object to object recognition module 104 in order to aid in identifying the object.

In this particular embodiment, once gesture recognition module 106 detects a pointing gesture, it notifies object recognition module 104 to identify the pointed-to object. Gesture recognition module 106 also notifies speech recognition module 112 so that speech recognition module 112 may identify any received voice input. Gesture recognition module 106 also notifies camera module 102 of the pointing gesture so that camera module 102 may begin recording.

If a “name” of an object is being provided by speech recognition module 112 to object recognition module 104, module 104 may utilize a recognition engine/video analysis engine (VAE) that comprises a software engine that analyzes analog and/or digital video to search for the named object. The particular software engine being used can vary based on what element is being searched for. In one embodiment, various video-analysis engines are stored in storage 118, each serving to identify a particular object (color, shape, automobile type, person, . . . , etc.).

Using the software engine, object recognition module 104 is able to “watch” the feed from camera module 102 and detect/identify selected objects (e.g, blue shirt). The particular VAE may be chosen based on the voice input to speech recognition module 112. The video-analysis engine may contain any of several object detectors as defined by the software engine. Each object detector “watches” the camera feed for a particular type of object.

The camera module 102 may also be provided with the VAE and “object” from speech recognition module 112 and auto-focus on the object so as to provide a clear(er) view of the object or a recorded video that may be accessed by the user. The user may stop the camera module 102 recording or live video feed with another gesture (e.g., the same gesture) or voice command.

In one or more embodiments, the object recognition module 104 may recognize multiple objects in a given scene and the user may perform a gesture recognized by the gesture recognition module 106 that causes the image rendering module 108 to perform an operation on one or more of the multiple recognized objects. For example, a user may point to several objects within the camera's field of view (FOV). This will cause object recognition module 104 to recognize the pointed-to objects (speech recognition module 112 may aid object recognition module 104 in recognizing the objects by providing the object recognition module 104 with verbal indications of the pointed-to objects).

FIG. 1 comprises an apparatus 100 for acquiring an image. The apparatus comprises a pre-buffer, a camera module configured to provide video to the pre-buffer, and a gesture recognition module configured to determine that a user is pointing by detecting a pointing gesture. The gesture recognition module is configured to output a notification of the pointing gesture.

An object recognition module is provided and configured to receive the notification of the pointing gesture and in response recognize an object the user is pointing to. An image rendering module is provided and configured to receive the notification of the pointing gesture and in response access the pre-buffer, identify the object within video stored in the pre-buffer, and crop an image of the object from the video stored in the pre-buffer, wherein the cropped image comprises an image of the object without the user's hand of finger covering the object.

A speech recognition module is provided and configured to receive the notification of the pointing gesture and in response listen for speech, decipher what was uttered, and provide what was uttered to the object recognition module.

An output module is provided and configured to provide the cropped image to a network and/or a graphical user interface.

As discussed above the object recognition module may utilize what was uttered to identify the object, Additionally, the pre-buffer comprises video taken at a time prior to the gesture recognition module determining that the user is pointing. Finally, the cropped image comprises an image taken at the time prior to the gesture recognition module determining that the user is pointing.

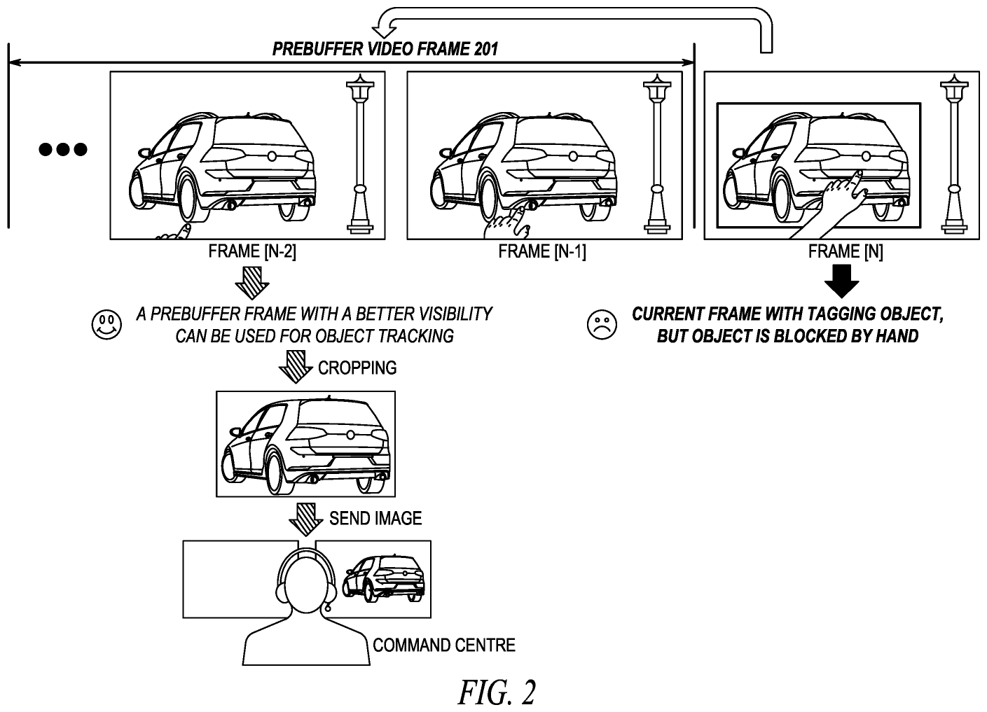

FIG. 2 illustrates the above-described technique for acquiring an image. During operation, camera module 102 is continuously providing video to pre-buffer 118 so that pre-buffer 118 can store a predetermined amount of video prior to re-writing the video with newer video. In one embodiment of the present invention, pre-buffer 118 continuously stores the last 30 seconds of video taken by camera module 102. In FIG. 2, the contents 201 of pre-buffer comprise frames (n-1), (n-2), . . ., etc. . At frame n, gesture recognition module 106 detects a pointing gesture and triggers camera module 102 to begin recording and storing video to storage 118. Around this time period, speech recognition module 112 may recognize the word “automobile” that was uttered by the user The gesture recognition module 112 is triggered to detect speech by a notification sent from gesture recognition module 106. If an utterance was heard around the time of pointing (e.g., within 2 seconds), then both the uttered speech and the video are provided to object recognition module 104. If no speech was detected by speech recognition module 112, then the video is provided to object recognition module 104. Object recognition module 104 receives the notification that a pointing gesture was detected and then attempts to identify the pointed-to object based on the camera feed (with the user's hand near the object) and possibly the utterance.

Once the pointed-to object has been identified in the video, object recognition module 104 attempts to recognize the same object within pre-buffer 118. The frames containing the object, along with information identifying the object (e.g., utterance, area of frame containing the object, . . . , etc.) are provided to image rendering module 108. Image rendering module 108 attempts to crop a best image of the pointed-to object from the pre-buffer 118. As discussed above, the best image of the object is identified as an image that does not comprise the user's pointing gesture. The cropped best image is output to module 110 and ultimately provided to other users via network 120.

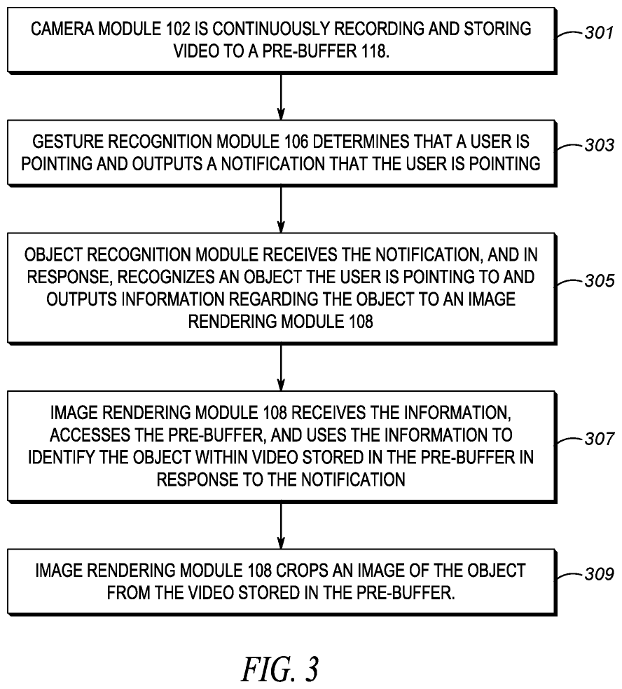

FIG. 3 is a flow chart showing operation of apparatus 100. The logic flow begins at step 301 where camera module 102 is continuously recording and storing video to a pre-buffer 118. (The pre-buffer comprises video taken at a time prior to determining that the user is pointing). At step 303, gesture recognition module 106 determines that a user is pointing and outputs a notification that the user is pointing. The logic flow continues to step 305 where object recognition module receives the notification, and in response, recognizes an object the user is pointing to and outputs information regarding the object to an image rendering module 108. At step 307, image rendering module 108 receives the information, accesses the pre-buffer, and uses the information to identify the object within video stored in the pre-buffer in response to the notification. Finally, at step 309, image rendering module 108 crops an image of the object from the video stored in the pre-buffer.

As discussed above, the cropped image comprises an image of the object without the user's hand of finger covering the object.

Additionally, as described above, a speech recognition module 112 may be provided to listen for speech in response to the notification being received and decipher what was uttered in response to the notification. What was uttered may be provided to the object recognition module in response to the notification so that the object recognition module utilizes what was uttered to identify the object.

As described above, the cropped image may be provided to a network and/or a graphical user interface. As discussed, the cropped image comprises an image taken at the time prior to determining that the user is pointing.

The above-described technique had the gesture recognition module outputting a notification that a pointing gesture had been detected to several other modules. This notification can be thought of as an “instruction” instructing the other modules to perform a particular action. For example, the gesture recognition module, by sending the notification of a recognized pointing gesture may be thought of as instructing the camera module to begin recording, instructing the object recognition module to identify a pointed-to object, instructing the speech recognition module to identify an utterance upon detection of the pointing gesture. . . . , etc.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” or “module” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A camera or structure that is “configured” in a certain way is configured in at least that way, but may also be configured in ways that are not listed.

It will be appreciated that some embodiments may be comprised of one or more generic or specialized processors (or “processing cameras”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage camera, a magnetic storage camera, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a pre-buffer;
a camera module configured to provide video to the pre-buffer;
a gesture recognition module configured to determine that a user is pointing by detecting a pointing gesture and output a notification that the pointing gesture has been detected;
an object recognition module configured to receive the notification of the pointing gesture and in response recognize an object the user is pointing to; and
an image rendering module configured to receive the notification of the pointing gesture and in response access the pre-buffer, identify the object within video stored in the pre-buffer, and crop an image of the object from the video stored in the pre-buffer, wherein the cropped image comprises an image of the object without the user's hand of finger covering the object.

2. The apparatus of claim 1 further comprising:
a speech recognition module configured to receive the notification of the pointing gesture and in response listen for speech, decipher what was uttered, and provide what was uttered to the object recognition module; and
wherein the object recognition module utilizes what was uttered to identify the object.

3. The apparatus of claim 2 further comprising:
an output module configured to provide the cropped image to a network and/or a graphical user interface.

4. The apparatus of claim 1 wherein the pre-buffer comprises video taken at a time prior to the gesture recognition module determining that the user is pointing.

5. The apparatus of claim 4 wherein the cropped image comprises an image taken at the time prior to the gesture recognition module determining that the user is pointing.

6. The apparatus of claim 1 further comprising:
a speech recognition module configured to listen for speech, decipher what was uttered, and provide what was uttered to the object recognition module; and
wherein the object recognition module utilizes what was uttered to identify the object;
wherein the gesture recognition module is also configured to:
instruct the camera module to begin recording upon detection of the pointing gesture;
instruct the object recognition module to identify a pointed-to object upon the detection of the pointing gesture;
instruct the speech recognition module to identify an utterance upon detection of the pointing gesture.

7. An apparatus comprising:
a pre-buffer;
a camera module configured to provide video to the pre-buffer;
a gesture recognition module configured to determine that a user is pointing by detecting a pointing gesture and output a notification of the pointing gesture;
an object recognition module configured to receive the notification of the pointing gesture and in response recognize an object the user is pointing to; and
an image rendering module configured to receive the notification of the pointing gesture and in response access the pre-buffer, identify the object within video stored in the pre-buffer, and crop an image of the object from the video stored in the pre-buffer, wherein the cropped image comprises an image of the object without the user's hand of finger covering the object;
a speech recognition module configured to receive the notification of the pointing gesture and in response listen for speech, decipher what was uttered, and provide what was uttered to the object recognition module;
an output module configured to provide the cropped image to a network and/or a graphical user interface;
wherein the object recognition module utilizes what was uttered to identify the object;
wherein the pre-buffer comprises video taken at a time prior to the gesture recognition module determining that the user is pointing;
wherein the cropped image comprises an image taken at the time prior to the gesture recognition module determining that the user is pointing.

8. A method comprising the steps of:
recording and storing video to a pre-buffer;
determine that a user is pointing and output a notification that the user is pointing;
recognizing an object the user is pointing to in response to the notification;
accessing the pre-buffer and identifying the object within video stored in the pre-buffer in response to the notification; and
cropping an image of the object from the video stored in the pre-buffer, wherein the cropped image comprises an image of the object without the user's hand of finger covering the object.

9. The method of claim 8 further comprising the steps of:
listening for speech in response to the notification;
deciphering what was uttered in response to the notification; and
providing what was uttered to an object recognition module in response to the notification; and
wherein the object recognition module utilizes what was uttered to identify the object.

10. The method of claim 9 further the step of:
providing the cropped image to a network and/or a graphical user interface.

11. The method of claim 8 wherein the pre-buffer comprises video taken at a time prior to determining that the user is pointing.

12. The method of claim 11 wherein the cropped image comprises an image taken at the time prior to determining that the user is pointing.
